(19) United States
(12) Patent Application Publication
(10) Pub. No.: US 2009/0117055 A1
(43) Pub. Date: May 7, 2009

(54) DISINFECTANT HAVING OZONE

(76) Inventors: Hwa Jeong Ryu, Busan (KR); Soo Tae Hwang, Busan (KR)

Correspondence Address: Hyun Jong Park;Park & Associates Intellectual Property Law LLC, Suite 106, 265 Bic Drive, Milford, CT, 06461, US

(21) Appl. No.: 12/336,291

(22) Filed: Dec. 16, 2008

Related U.S. Application Data
(63) Continuation of application No. PCT/KR2007/002945, filed on Jun. 18, 2007.

(30) Foreign Application Priority Data
Jun. 16, 2006 (KR) 10-2006-0054271
Jun. 15, 2007 (KR) 10-2007-0059002

(51) Int. Cl. A01N 25/06; A01N 59/00

(52) U.S. Cl. 424/43; 424/613

(57) ABSTRACT

Provided is a disinfectant which is not harmful to the human body and has sterilizing power in atmospheric conditions. Liquid paraffin or Vaseline containing ozone is applied on the human body, or medical equipment to be disinfected is dipped therein. Thus, the disinfection of medical equipment is easily and conveniently achieved. When used on the human body, the disinfectant aids in the treatment of wounds because the disinfectant has a disinfection effect and a moisturizing effect.

### REFERENCE TO RELATED APPLICATIONS

This a continuation of pending International Patent Application PCT/KR2007/002945 filed on Jun. 18, 2007, which designates the United States and claims priority of Korean Patent Applications No. 10-2006-0054271 filed on Jun. 16, 2006 and No. 10-2007-0059002 filed on Jun. 15, 2007, the entire contents of which are incorporated herein by reference.

### FIELD OF THE INVENTION

The present invention relates to a disinfectant containing ozone, and more particularly to a disinfectant containing ozone, in which ozone is input into liquid paraffin or Vaseline so that the liquid paraffin or Vaseline containing ozone can perform disinfection.

### BACKGROUND OF THE INVENTION

Medical equipment used in hospitals, etc. must be disinfected after every usage because the equipment is used for many patients. Especially, dental equipment may transfer bacteria from a previous patient's mouth to a subsequent patient's mouth through the surface or interior of the dental equipment if the dental equipment is not disinfected, because the dental equipment is put into mouths.

Conventionally, high temperature steam generated from boiling water is sprayed on the surface of medical equipment to disinfect the medical equipment. The surface contacted by the steam is disinfected, however, the conventional disinfection method has a problem in that bacteria still exist in areas that the steam does not reach. Steam or water, especially, is difficult to use for disinfection because steam or water cannot reach all corners due to surface tension, etc. To solve the problem, a disinfection method in which medical equipment is dipped in liquid paraffin after heating the liquid paraffin to a high temperature has been developed and used.

However, the disinfection method using steam or liquid paraffin at a high temperature has problems in that a heating apparatus must be provided to heat water or liquid paraffin, and in that it is not easy to manage the heated steam or liquid paraffin because they are dangerous and thus, must be carefully handled.

To solve these problems, a lot of research is being conducted and research using ozone is being actively conducted. Ozone is an excellent disinfectant, however, it is harmful to the human body, and thus, in Korea, an Ozone Warning is pronounced in the case where at least 0.012 PPM ozone is detected in the atmosphere. Thus, ozone has a problem in that ozone is difficult to use because ozone must be handled carefully. Further, ozone has a problem in that ozone is difficult to preserve for a long time because ozone is easily dissolved.

To solve these problems, a method of preserving ozone for a long time has been researched, wherein ozone emitted into the air is suppressed by containing the ozone in vegetable oil, such as olive oil. Olive oil containing ozone is used for treating acne.

However, the olive oil has a problem in that vegetable oil is oxidized when preserved for a long time and in that the sterilizing power thereof is lower than that of conventional disinfectants.

### SUMMARY OF THE INVENTION

Accordingly, the present invention has been made to solve the above problems, and an object of the present invention is to provide a disinfectant which can be used to disinfect medical equipment etc. without heating due to its excellent sterilizing power even at low temperatures, and can be directly applied to the human body to prevent the infection of wounds, or can be directly used for lubrication and disinfection of a food manufacturing line because the disinfectant is not harmful to the human body.

In order to achieve the above objects, there is provided a disinfectant containing ozone, comprising liquid paraffin or Vaseline retaining ozone therein, the ozone being captured by mixing ozone and liquid paraffin or Vaseline with stirring.

In a preferable embodiment, the liquid paraffin is mixed with ozokerite to form a gel.

In another embodiment, the disinfectant is combined with high pressure gas in a container or a sprayer.

In a further embodiment, the disinfectant is contained in a sprayer and is ready to be sprayed on skin or an object when necessary.

As is apparent from the above descriptions, the present invention provides advantages in that it is easy to handle the disinfectant because ozone input into liquid paraffin or Vaseline performs disinfection at low temperature, and thus, heating is not necessary.

Further, the present invention also provides advantages in that disinfection is convenient because ozone contained in liquid paraffin or Vaseline, which is not harmful to the human body, performs disinfection and thus, there is no reaction when used on the human body, and a film is formed to prevent the continual invasion of bacteria when applied to the skin.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a photograph showing the sterilizing power of general liquid paraffin and liquid paraffin containing ozone against S. mutans bacteria

FIG. 2 is a photograph showing the sterilizing power of general Vaseline and Vaseline containing ozone against S. mutans bacteria.

FIG. 3 is a photograph showing the sterilizing power of general olive oil and olive oil containing ozone against S. mutans bacteria.

FIG. 4 is a photograph showing the sterilizing power of liquid paraffin containing ozone according to the time exposed to ozone.

FIG. 5 is a photograph showing the sterilizing power of Vaseline containing ozone against T. menlagrophytes bacteria

FIG. 6 is a photograph showing the sterilizing power of PM against T. mentagrophytes bacteria

FIG. 7 is a photograph showing the sterilizing power of NAMISOL.

### DETAILED DESCRIPTION OF THE INVENTION

The disinfectant containing ozone of the present invention will hereinafter be described in further detail according to a preferred embodiment thereof.

At first, liquid paraffin in a liquid state (having a specific gravity of about 0.832) is put into a sealed container and one end of a pipe of an ozone generator is positioned inside the liquid paraffin. Then, ozone is supplied into the liquid paraffin and stirred in order to thoroughly mix it If the ozone is supplied for too long, such that the density of ozone is increased, the sterilizing power thereof will be increased, but the paraffin may harm the human body. If the ozone is supplied for too short a time, the density of ozone will be too low and thus, the sterilizing power will be low.

Accordingly, in the present invention, the disinfectant to be used for medical equipment is imparted with high ozone density by being supplied with ozone for a long time (at least 24 hours) because the equipment is to be washed after disinfection. The disinfectant to be used for the human body is imparted with low ozone density by being supplied with ozone for several hours.

Further, the liquid paraffin cannot continually stick to the human body when used on the human body, and liquid paraffin of a highly viscous or gel type, such as Vaseline, due to the addition of other material, is used.

At this time, in order to make the liquid paraffin into a gel such as Vaseline, liquid paraffin containing ozone is mixed with ozokerite. The reason for adding ozokerite after providing ozone is that providing ozone into liquid paraffin in a liquid state is easier than providing ozone into a gel such as Vaseline. However, providing ozone into a gel such as Vaseline, as above, is acceptable.

When the disinfectant is used for medical equipment, the medical equipment is dipped into the disinfectant so that the disinfectant reaches the interior and the exterior of the medical equipment to disinfect the medical equipment. In this case, disinfection may be difficult if viscosity is high, and therefore, liquid paraffin having low viscosity is used.

Injecting ozone into natural Vaseline instead of inputting ozone into liquid paraffin is possible.

Hereinafter, the effect of disinfectant containing ozone of the present invention will be described in further detail according to a preferred embodiment.

First, sterilizing power of liquid paraffin and Vaseline containing ozone is compared with conventional olive oil containing ozone.

In the experiment for this, liquid paraffin containing ozone and ozonized olive oil, in which ozone had been input into the olive oil, were used.

In the experiment, one S. mutans colony is vaccinated into 10 ml of BHI broth and is cultured with shaking. The culture medium is evenly applied again on a BHI agar plate, to which liquid paraffin, Vaseline and olive oil containing ozone are applied. At this time, liquid paraffin, Vaseline and olive oil without ozone are also applied to compare the sterilizing power thereof.

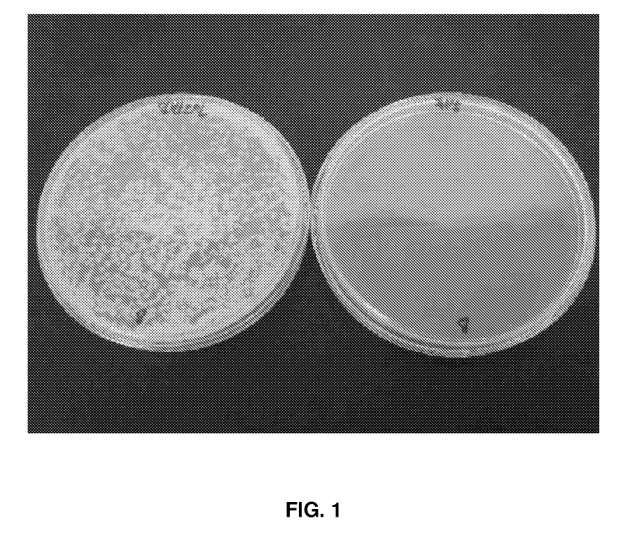

FIG. 1 shows the comparison between general liquid paraffin and liquid paraffin containing ozone. The liquid paraffin on the right side has no colonies, and thus is completely disinfected.

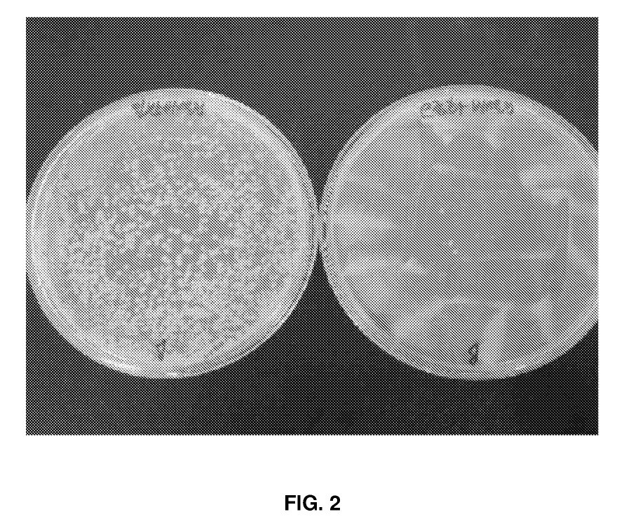

FIG. 2 shows a comparison between general Vaseline and the Vaseline containing ozone. A few colonies exist in the Vaseline containing ozone on the right-hand side.

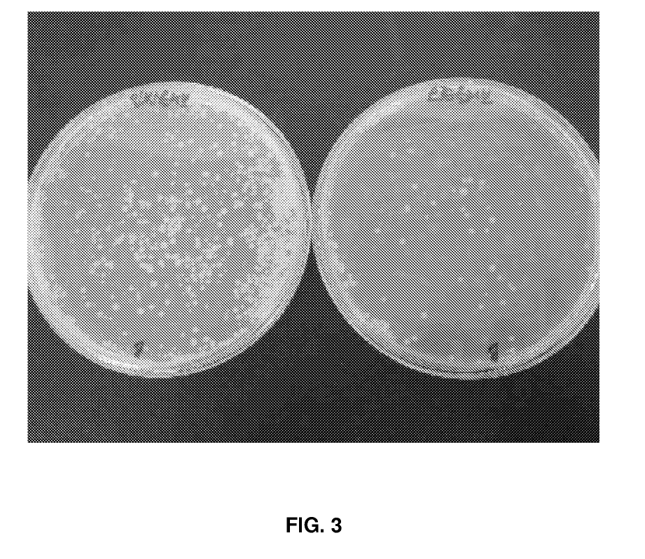

FIG. 3 shows a comparison between general olive oil and olive oil containing ozone. The olive oil containing ozone, at right, shows several colonies. Accordingly, olive oil containing ozone has weak sterilizing power which is lower than that of liquid paraffin or Vaseline containing ozone.

Then, the sterilizing power of liquid paraffin containing ozone is compared according to the time of exposure to ozone. For this, liquid paraffin was fed with ozone for each of 10 minutes, 1 hour, 4 hours, 10 hours and 24 hours, mixed with a T. mentagrophytes strain that causes athlete's foot. One minute later, the strain was separated through centrifugation, followed by incubation at 25° C. for 3 days in an incubator.

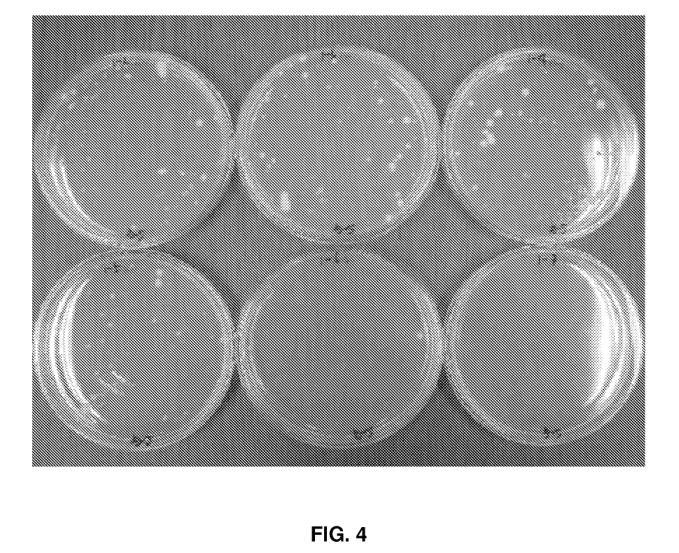

The results are shown in FIG. 4. shows the result of the experiment. From the left upper, liquid paraffin exposed to ozone for 10 minutes, 1 hour, 2 hours, 4 hours, 10 hours and 24 hours is shown. The result shows that the sterilizing power of the disinfectant of the present invention increases according to the time exposed to ozone.

Then, a comparison was conducted between the invention and commercially available drugs for athlete's foot for activity on T. mentagrophytes.

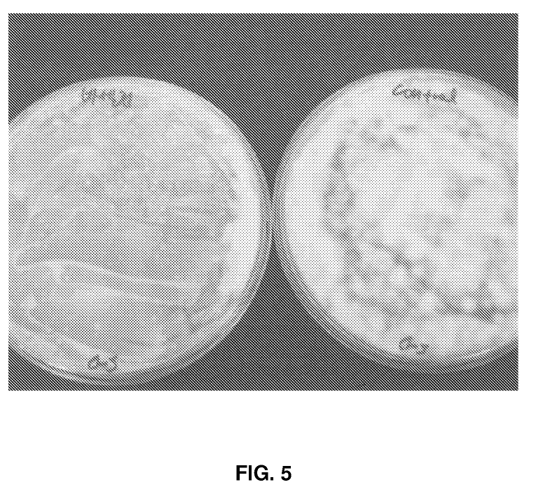

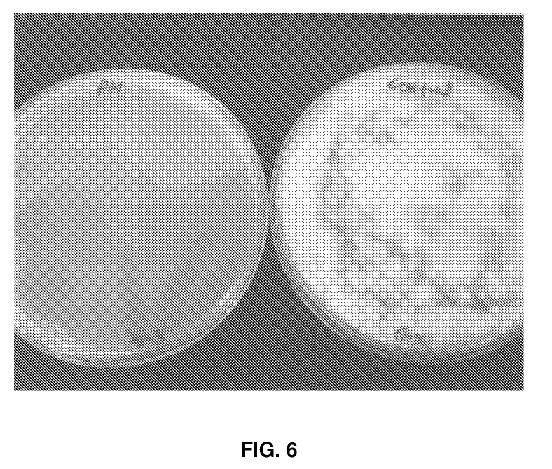

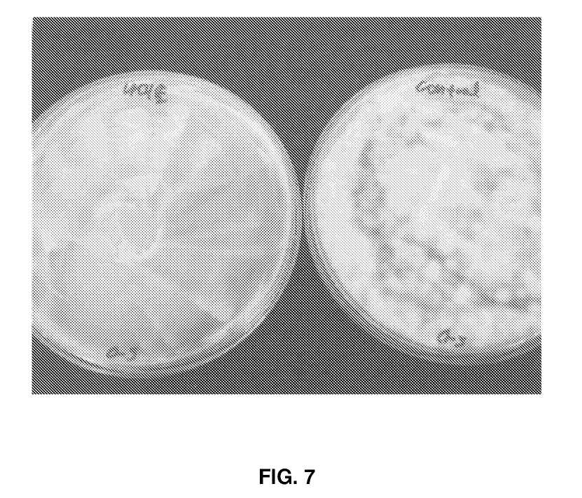

FIGS. 5 to 7 show the comparison between drugs for athlete's foot (PM and NAMISOL) and Vaseline containing ozone of the present invention. The result of the application of Vaseline containing ozone according to the present invention is shown in FIG. 5, the result of the application of PM in FIG. 6, and the result of the application of NAMISOL in FIG. 7.

Commercially available drugs for athlete's foot show better effects than Vaseline containing ozone of the present invention on T. mentagrophytes. However, Vaseline containing ozone of the present invention causes neither resistance, nor irritates the skin, but retains the moisturizing effect of Vaseline, therefore, the Vaseline containing ozone according to the present invention is expected to be very clinically effective.

The disinfectant containing ozone of the present invention may have various viscosities and ozone concentrations depending on the purposes thereof. For instance, when used on the human body, the disinfectant is made in an ointment form in order to prevent separation from the skin upon application, prevent the invasion of bacteria, and give a moisturizing effect. When used for medical equipment, the disinfectant is made in a liquid form having a low viscosity to disinfect medical equipment by dipping it.

In addition to the disinfection of skin or medical equipment, the disinfectant containing ozone can be used for the lubrication and disinfection of equipment such as a food manufacturing line because the liquid paraffin, containing ozone, can be used as a lubricant.

In addition, the disinfectant containing ozone is possible to spray after it is combined with high pressure gas in a sprayer or container. Disinfection is conveniently achieved by spraying the disinfectant containing ozone on a wound in an outdoor place.

### INDUSTRIAL APPLICABILITY

As described above, the disinfectant containing ozone of the present invention can be safely used because the small amount of ozone in liquid paraffin or Vaseline is not harmful to the human body when applied, even though the density of ozone in the disinfectant containing ozone is higher than that in the atmosphere.

The disinfectant containing ozone of the present invention can be easily made, and can be used for multiple purposes, such as the disinfection of the human body and medical equipment, and the lubrication and disinfection of food manufacturing lines, etc.

In addition, the disinfectant does not need to be heated when disinfecting medical equipment because the disinfectant has excellent sterilizing power in atmospheric conditions.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A disinfectant containing ozone, comprising liquid paraffin or Vaseline retaining ozone therein, the ozone being captured by mixing ozone and liquid paraffin or Vaseline with stirring.

2. The disinfectant containing ozone as set forth in claim 1, wherein the liquid paraffin is mixed with ozokerite to form a gel.

3. The disinfectant containing ozone as set forth in claim 1, wherein the disinfectant is combined with high pressure gas in a container or a sprayer.

4. The disinfectant containing ozone as set forth in claim 1, wherein the disinfectant is contained in a sprayer and is ready to be sprayed on skin or an object when necessary.
